(19) United States
(12) Patent Application Publication
(10) Pub. No.: US 2008/0188200 A1
(43) Pub. Date: Aug. 7, 2008

(54) Security key generation for wireless communications

(75) Inventor: Dan Forsberg, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 11/730,536

(22) Filed: Apr. 2, 2007

(30) Foreign Application Priority Data
Feb. 2, 2007 (FI) 20070095

(51) Int. Cl. H04M 1/66

(52) U.S. Cl. 455/410

(57) ABSTRACT

Generating and re-generating security keys for wireless communication over a Radio Access Network efficiently without having to synchronize sequence numbers. In response to a predetermined event, at least one security key is generated for use in wireless communication between a mobile station and an access network element by utilizing a randomly allocated temporary identifier associated with the mobile station.

### BACKGROUND OF THE INVENTION

1. Field of the Invention

The invention generally relates to telecommunications. In particular, the invention relates to security key generation for wireless communication.

2. Description of the Related Art

A pair of security keys—e.g. a ciphering key and an integrity protection key—may today be used to secure wireless telecommunications traffic over a Radio Access Network. For example, present implementations of Third Generation Partnership Project (3GPP) mobile telecommunications networks typically implement a security key pair for such a purpose.

Typically, ciphering used in these implementations is of stream ciphering type (as opposed to block ciphering). As is known in the art, a stream cipher encrypts plaintext digits (often single bits or bytes) one at a time. Therefore, the transformation of successive digits varies during the encryption.

Based on a ciphering key, a stream cipher generates a key stream which can be combined with the plaintext digits. Stream ciphers are often used in applications where plaintext comes in quantities of unknowable length, such as e.g. wireless communications.

However, a continuous key stream needs to be maintained even during handovers and state transitions (for example, when a mobile station goes from idle state or mode to active state or mode). To allow this, one approach taught by prior art related to Radio Resource Control protocol (used e.g. in 3GPP mobile telecommunications) includes synchronizing packet sequence numbers during handovers in order to maintain continuous key streams. This synchronization, however, introduces significant drawbacks related to data security. For example, the synchronization may result in the sequence numbers changing in a predictable way, thus providing a potential opportunity for abuse.

Another approach taught by prior art is to use a random parameter called nonce as input in deriving the security keys, when returning to a prior base station and using keying material that is otherwise the same, thus allowing the security keys to be refreshed. This approach is used e.g. in Wireless Local Access Networks or WLANs. However, this approach has a significant drawback in that signaling the nonces introduces a large amount of additional overhead and complexity.

### SUMMARY OF THE INVENTION

A first aspect of the present invention is a method in which, in response to a predetermined event, at least one security key is generated for use in wireless communication between a mobile station and an access network element by utilizing a randomly allocated temporary identifier associated with the mobile station.

A second aspect of the present invention is an apparatus which comprises a security key generator configured to generate, in response to a predetermined event, at least one security key for use in wireless communication between a mobile station and an access network element by utilizing a randomly allocated temporary identifier associated with the mobile station.

A third aspect of the present invention is an apparatus which comprises a security key generating means for generating, in response to a predetermined event, at least one security key for use in wireless communication between a mobile station and an access network element by utilizing a randomly allocated temporary identifier associated with the mobile station.

A fourth aspect of the present invention is a computer program embodied on a computer readable medium, the computer program controlling a data-processing device to perform:

generating, in response to a predetermined event, at least one security key for use in wireless communication between a mobile station and an access network element by utilizing a randomly allocated temporary identifier associated with the mobile station.

In an embodiment of the invention, the utilizing the randomly allocated temporary identifier in the generating of the at least one security key further comprises concatenating the randomly allocated temporary identifier with predetermined security context data.

In an embodiment of the invention, the at least one security key to be generated comprises at least one of a ciphering key and an integrity protection key.

In an embodiment of the invention, the access network element comprises a present access point.

In an embodiment of the invention, the predetermined event comprises a handover of the mobile station from a prior access point to the present access point.

In an embodiment of the invention, the randomly allocated temporary identifier associated with the mobile station comprises a radio link identifier randomly allocated to a radio link between the mobile station and the present access point.

In an embodiment of the invention, utilizing an access point identifier allocated to the present access point in the generating of the at least one security key.

In an embodiment of the invention, the randomly allocated temporary identifier associated with the mobile station comprises a temporary identifier randomly allocated to the mobile station.

In an embodiment of the invention, the at least one security key to be generated comprises a security key for use by radio resource control signaling.

In an embodiment of the invention, the access network element comprises at least one of a mobility management element and a user data gateway.

In an embodiment of the invention, the predetermined event comprises a state change at the mobile station from a first state to a second state.

In an embodiment of the invention, the randomly allocated temporary identifier associated with the mobile station comprises a temporary identifier randomly allocated to the mobile station.

In an embodiment of the invention, utilizing a routing area identifier allocated to a present routing area in the generating of the at least one security key.

In an embodiment of the invention, the at least one security key to be generated comprises a security key for use by one of non access stratum signaling and user data protection.

In an embodiment of the invention, the apparatus of the second or third aspect is arranged at the mobile station.

In an embodiment of the invention, the apparatus of the second or third aspect is arranged at the access network element.

The embodiments of the invention described above may be used in any combination with each other. Several of the embodiments may be combined together to form a further embodiment of the invention. A method, an apparatus, or a computer program which is an aspect of the invention may comprise at least one of the embodiments of the invention described above.

The invention allows generating and re-generating security keys for wireless communication over a Radio Access Network without having to synchronize sequence numbers. Furthermore, the invention allows generating and re-generating these security keys in an efficient manner.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a signaling diagram illustrating a method according to an embodiment of the present invention;

FIG. 2 is a signaling diagram illustrating a method according to another embodiment of the present invention; and

FIG. 3 is a block diagram illustrating apparatuses according to an embodiment of the present invention.

### DETAILED DESCRIPTION OF THE PREFERRED EMBODIMENTS

Reference will now be made in detail to the embodiments of the invention, examples of which are illustrated in the accompanying drawings.

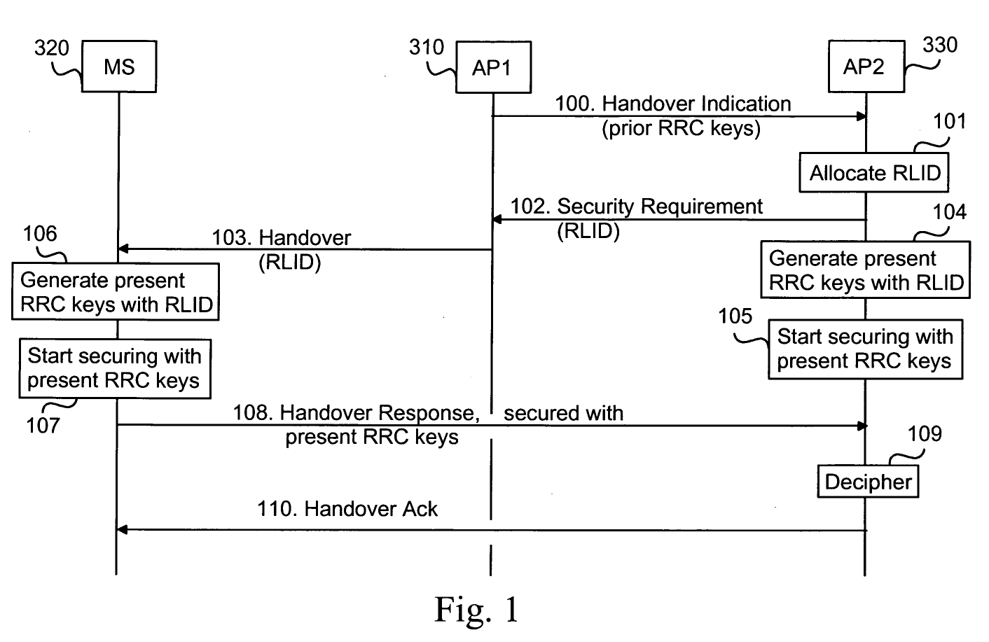

FIG. 1 is a signaling diagram illustrating a method according to an embodiment of the present invention. At step 100, a first access point 310 sends a handover indication message to a second access point 330. The first access point 310 has been using a prior pair of security keys in communication with a mobile station 320. The handover indication message indicates that the mobile station 320 is about to be handed over from the first or prior access point 310 to the second or present access point 330. In an embodiment, the handover indication message includes information indicating the prior pair of security keys. Furthermore, in an embodiment, the handover indication message of step 100 may include mobile station security capability information indicating security capabilities of the mobile station 320. Furthermore, in an embodiment, the handover indication message of step 100 may include information indicating which security algorithms the mobile station 320 supports

In an embodiment, the security keys are used to secure Radio Access Network traffic, e.g. by at least one of ciphering the Radio Access Network traffic and protecting the integrity of the Radio Access Network traffic. More particularly, in the example of FIG. 1, the security keys to be generated may be e.g. RRC keys used to secure Radio Resource Control (RRC) signaling between the mobile station 320 and the second access point 330.

In response, the second access point 330 randomly allocates a radio link identifier (RLID) to a radio link between the mobile station 320 and the present or second access point 330, step 101. At step 102, the second access point 330 sends a security requirement message to the first access point 310 which security requirement message includes the allocated radio link identifier.

In response, a handover message is sent from the first access point 310 to the mobile station 320 instructing the mobile station 320 to handover to the second access point 330 and including the allocated radio link identifier, step 103.

At step 104, the second access point 330 generates at least one security key (a key pair comprising a ciphering key and an integrity protection key in the example illustrated in FIG. 1) for use in wireless communication between the mobile station 320 and the second access point 330 by utilizing the allocated radio link identifier. Furthermore, an access point identifier allocated to the present or second access point 330 may also be used while generating the at least one security key, in addition to the allocated radio link identifier. Similarly, a temporary identifier randomly allocated to the mobile station 320 (such as e.g. a cell radio network temporary identifier or C-RNTI, or the like) may also be used while generating the at least one security key, in addition to the allocated radio link identifier.

In an embodiment of the invention, the second access point 330 generates the at least one security key by concatenating the allocated radio link identifier with predetermined security context data. For example, a key derivation function such as the following may be used:

security keys (CK′ || IK′) = KDF(CK || IK ||
RLID || AP Identity || “constant string”);

wherein ∥ denotes concatenation, CK denotes ciphering key, IK denotes integrity protection key, AP identity denotes an access point identifier allocated to the present access point 330, and KDF denotes key derivation function.

At step 105, the second access point 330 starts to secure its Radio Access Network traffic using its generated security key pair e.g. by at least one of starting to cipher the Radio Access Network traffic and starting to protect the integrity of the Radio Access Network traffic.

Correspondingly, at step 106, the mobile station 320 generates at least one security key (a key pair comprising a ciphering key and an integrity protection key in the example illustrated in FIG. 1) for use in the wireless communication between the mobile station 320 and the second access point 330 by utilizing the allocated radio link identifier it received at step 103. Also, at step 10t, the mobile station 320 starts to secure its Radio Access Network traffic using its generated security key pair e.g. by at least one of starting to cipher the Radio Access Network traffic and starting to protect the integrity of the Radio Access Network traffic.

At step 108, a handover response message is sent from the mobile station 320 to the second access point 330. The handover response message is now secured with the newly generated security keys. The second access point 330 deciphers the received handover response message, step 109, and responds by sending a handover acknowledgement message, step 110.

In an embodiment, the handover indication message of step 100 may be e.g. a Context Transfer message of a 3G mobile telecommunications network, or the like. Furthermore, the security requirement message of step 102 may be e.g. a Context Transfer acknowledgement message of a 3G mobile telecommunications network, or the like. Furthermore, the handover message of step 103 may be e.g. a Handover Command message of a 3G mobile telecommunications network, or the like. Furthermore, the handover response message of step 108 may be e.g. a Handover Command Response message of a 3G mobile telecommunications network, or the like.

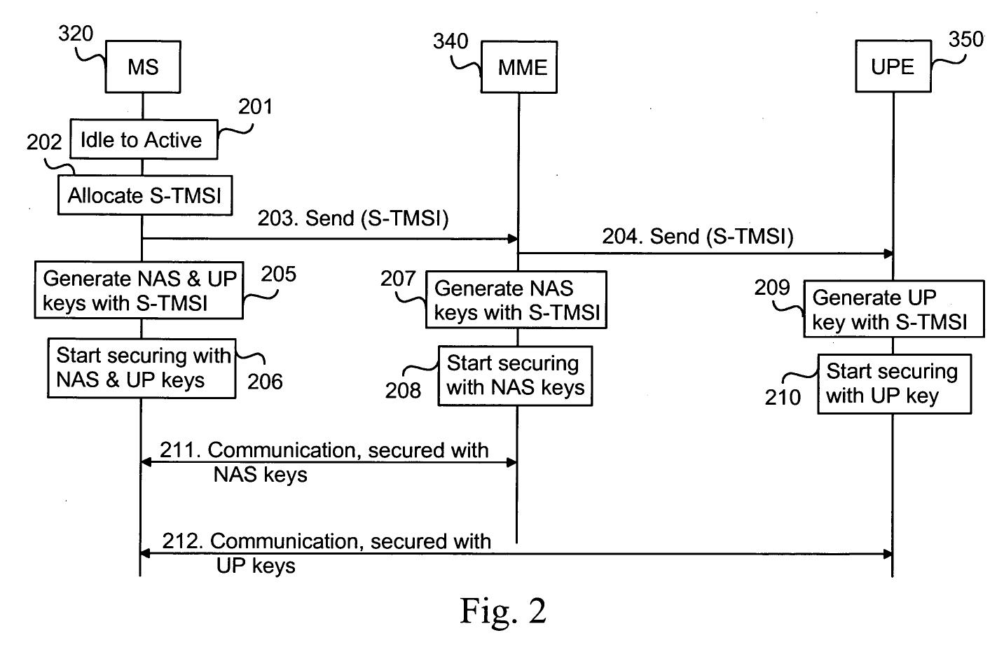

FIG. 2 is a signaling diagram illustrating a method according to another embodiment of the present invention. At step 201, the mobile station 320 goes from idle state to active state. In response, a temporary identifier is randomly allocated to the mobile station 320, step 202. In an embodiment, the temporary identifier may be e.g. a temporary mobile subscriber identity (TMSI), such as S-TMSI used e.g. in LTE (Long Term Evolution) enhanced 3GPP mobile telecommunications network technology to identify a mobile station in one routing area. In yet another embodiment, the temporary identifier may be e.g. a Routing Area Identifier (RAI) associated with the mobile station 322.

In an embodiment, a given S-TMSI is not reused with a same mobile station with same keying material. In other words, the S-TMSI is allocated randomly. One way to achieve this is to make some of the bits of a given S-TMSI increase every time the S-TMSI is re-allocated in order to make the resulting S-TMSI different from the previous one. After consuming all the bit combinations, the keying material needs to be refreshed (e.g. with AKA (Authentication and Key Agreement) re-authentication). Another way to achieve this is to choose the S-TMSI randomly and ensure that the probability of having the same S-TMSI for the same mobile station with the same keying material is substantially low.

At step 203, the allocated temporary identifier S-TMSI is signaled to a mobility management element 340. In an embodiment, the mobility management element 340 may be e.g. a Mobility Management Entity (MME) of a LTE enhanced 3GPP mobile telecommunications network. In an optional step 204, the S-TMSI is further signaled to a user data gateway 350. In an embodiment, the user data gateway 350 may be e.g. a User Plane Entity (UPE) of a LTE enhanced 3GPP mobile telecommunications network.

At step 205, the mobile station 320 generates at least one first security key (a first key pair comprising a first ciphering key and a first integrity protection key in the example illustrated in FIG. 2) for use in wireless communication between the mobile station 320 and the mobility management element 340 by utilizing the allocated temporary identifier S-TMSI. In an embodiment, the first security keys to be generated may be e.g. NAS keys used to secure Non Access Stratum (NAS) signaling between the mobile station 320 and the mobility management element 340.

Furthermore, in an embodiment, the mobile station 320 generates at least one second security key (a second ciphering key in the example illustrated in FIG. 2) for use in wireless communication between the mobile station 320 and the user data, gateway 350 by utilizing the allocated temporary identifier S-TMSI, step 205. In an embodiment, the second security key to be generated may be e.g. a UP key used to secure User Plane (UP) data between the mobile station 320 and the user data gateway 350. Again, the first and second security keys may be generated e.g. by concatenating the allocated temporary identifier S-TMSI with predetermined security context data.

At step 206, the mobile station 320 starts to secure its Radio Access Network traffic with the mobility management element 340 and the user data gateway 350 using its generated security keys e.g. by at least one of starting to cipher the Radio Access Network traffic and starting to protect the integrity of the Radio Access Network traffic.

Correspondingly, at step 205, the mobility management element 340 generates at least one first security key (a first key pair comprising a first ciphering key and a first integrity protection key in the example illustrated in FIG. 2) for use in wireless communication between the mobile station 320 and the mobility management element 340 by utilizing the allocated temporary identifier S-TMSI received at step 203. In an embodiment, the first security keys to be generated may be e.g. NAS keys used to secure Non Access Stratum (NAS) signaling between the mobile station 320 and the mobility management element 340. Again, the NAS keys may be generated e.g. by concatenating the allocated temporary identifier S-TMSI with predetermined security context data.

At step 208, the mobility management element 340 starts to secure its Radio Access Network traffic with the mobile station 320 using its generated security keys e.g. by at least one of starting to cipher the Radio Access Network traffic and starting to protect the integrity of the Radio Access Network traffic.

Correspondingly, at step 209, the user data gateway 350 generates at least one second security key (a second ciphering key in the example illustrated in FIG. 2) for use in wireless communication between the mobile station 320 and the user data gateway 350 by utilizing the allocated temporary identifier S-TMSI, step 205. In an embodiment, the second security key to be generated may be e.g. a UP key used to secure User Plane (UP) data between the mobile station 320 and the user data gateway 350. Again, the UP key may be generated e.g. by concatenating the allocated temporary identifier S-TMSI with predetermined security context data.

At step 206, the user data gateway 350 starts to secure its Radio Access Network traffic with the mobile station 320 using its generated security key e.g. by starting to cipher the Radio Access Network traffic. Steps 211-212 represent communication secured with the above generated security keys.

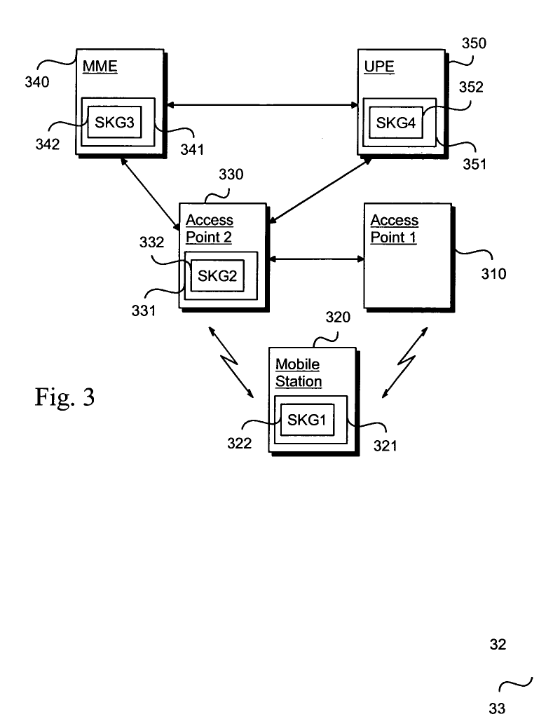

FIG. 3 is a block diagram illustrating apparatuses according to an embodiment of the present invention. FIG. 3 includes the first or prior access point 310, the second or present access point 330, the mobile station 320, the mobility management element 340, and the user data gateway 350.

In the embodiment illustrated in FIG. 3, the second or present access point 330 comprises an apparatus 331 which comprises a second security key generator 332 configured to generate, in response to a predetermined event, at least one security key for use in wireless communication between the mobile station 320 and the second access point 330 by utilizing a randomly allocated temporary identifier associated with the mobile station 320.

Furthermore, in the embodiment illustrated in FIG. 3, the mobility management element 340 comprises an apparatus 341 which comprises a third security key generator 342 configured to generate, in response to a predetermined event, at least one security key for use in wireless communication between the mobile station 320 and the mobility management element 340 by utilizing a randomly allocated temporary identifier associated with the mobile station 320.

Furthermore, in the embodiment illustrated in FIG. 3, the user data gateway 350 comprises an apparatus 351 which comprises a fourth security key generator 352 configured to generate, in response to a predetermined event, at least one security key for use in wireless communication between the mobile station 320 and the user data gateway 350 by utilizing a randomly allocated temporary identifier associated with the mobile station 320.

Furthermore, in the embodiment illustrated in FIG. 3, the mobile station 320 comprises an apparatus 321 which comprises a first security key generator 322 configured to generate, in response to a predetermined event, at least one security key for use in wireless communication between the mobile station 320 and the mobility management element 340 and/or at least one security key for use in wireless communication between the mobile station 320 and the user data gateway 350 by utilizing a randomly allocated temporary identifier associated with the mobile station 320.

In an embodiment, the first access point 310 may comprise a base station, an Access Router, an IPsec gateway (IPsec referring to “Internet protocol security” which is a suite of protocols for securing Internet Protocol communications), a relay station of a wireless ad hoc network, a Node-B network element of a 3G mobile telecommunications network, or the like.

In an embodiment, the second access point 330 may comprise a base station, an Access Router, an IPsec gateway (IPsec referring to “Internet protocol security” which is a suite of protocols for securing Internet Protocol communications), a relay station of a wireless ad hoc network, a Node-B network element of a 3G mobile telecommunications network, or the like.

In an embodiment, the mobile station 320 may comprise a User Equipment of a 3G mobile telecommunications network, or the like. In an embodiment, the mobility management element 340 may comprise a Mobility Management Entity of a LTE enhanced 3GPP mobile telecommunications network. In an embodiment, the user data gateway 350 may comprise a User Plane Entity of a LTE enhanced 3GPP mobile telecommunications network.

The exemplary embodiments can include, for example, any suitable servers, workstations, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, 3G communications networks, 3G communications networks enhanced with LTE technology (Long Term Evolution), 3G communications networks enhanced with SAE technology (System Architecture Evolution), Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art (s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDR, CD-RW, DVD, DVD-ROM, DVD+RW, DVD+R, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

What is claimed is:

1. A method, comprising:
generating, in response to a predetermined event, at least one security key for use in wireless communication between a mobile station and an access network element by utilizing a randomly allocated temporary identifier associated with the mobile station.

2. The method according to claim 1, wherein the utilizing of the randomly allocated temporary identifier in the generating of the at least one security key further comprises concatenating the randomly allocated temporary identifier with predetermined security context data.

3. The method according to claim 1, wherein the generating of the at least one security key comprises generating at least one of a ciphering key and an integrity protection key.

4. The method according to claim 1, wherein the access network element comprises a present access point.

5. The method according to claim 4, wherein the predetermined event comprises a handover of the mobile station from a prior access point to the present access point.

6. The method according to claim 4, wherein the utilizing of the randomly allocated temporary identifier associated with the mobile station comprises allocating a radio link identifier randomly to a radio link between the mobile station and the present access point.

7. The method according to claim 6, further comprising:
utilizing an access point identifier allocated to the present access point in the generating of the at least one security key.

8. The method according to claim 4, wherein the utilizing of the randomly allocated temporary identifier associated with the mobile station comprises randomly allocating a temporary identifier to the mobile station.

9. The method according to claim 4, wherein the generating of the at least one security key comprises a security key by radio resource control signaling.

10. The method according to claim 1, wherein the access network element comprises at least one of a mobility management element and a user data gateway.

11. The method according to claim 10, wherein the predetermined event comprises a state change at the mobile station from a first state to a second state.

12. The method according to claim 1D, wherein the utilizing of the randomly allocated temporary identifier associated with the mobile station comprises allocating a temporary identifier randomly to the mobile station.

13. The method according to claim 12, further comprising:
utilizing a routing area identifier allocated to a present routing area in the generating of the at least one security key.

14. The method according to claim 10, wherein the generating of the at least one security key comprises a security key by one of non access stratum signaling and user data protection.

15. An apparatus, comprising:
a security key generator configured to generate, in response to a predetermined event, at least one security key for use in wireless communication between a mobile station and an access network element by utilizing a randomly allocated temporary identifier associated with the mobile station.

16. The apparatus according to claim 15, wherein the security key generator is further configured to perform the utilizing of the randomly allocated temporary identifier in the generating of the at least one security key by concatenating the randomly allocated temporary identifier with predetermined security context data.

17. The apparatus according to claim 15, wherein the at least one security key to be generated comprises at least one of a ciphering key and an integrity protection key.

18. The apparatus according to claim 15, wherein the apparatus is arranged at the mobile station.

19. The apparatus according to claim 15, wherein the apparatus is arranged at the access network element.

20. The apparatus according to claim 15, wherein the access network element comprises a present access point.

21. The apparatus according to claim 20, wherein the predetermined event comprises a handover of the mobile station from a prior access point to the present access point.

22. The apparatus according to claim 20, wherein the randomly allocated temporary identifier associated with the mobile station comprises a radio link identifier randomly allocated to a radio link between the mobile station and the present access point.

23. The apparatus according to claim 22, wherein the security key generator is further configured to utilize an access point identifier allocated to the present access point to generate the at least one security key.

24. The apparatus according to claim 20, wherein the randomly allocated temporary identifier associated with the mobile station comprises a temporary identifier randomly allocated to the mobile station.

25. The apparatus according to claim 20, wherein the at least one security key to be generated comprises a security key for use by radio resource control signaling.

26. The apparatus according to claim 15, wherein the access network element comprises at least one of a mobility management element and a user data gateway.

27. The apparatus according to claim 26, wherein the predetermined event comprises a state change at the mobile station from a first state to a second state.

28. The apparatus according to claim 26, wherein the randomly allocated temporary identifier associated with the mobile station comprises a temporary identifier randomly allocated to the mobile station.

29. The apparatus according to claim 28, wherein the security key generator is further configured to utilize a routing area identifier allocated to a present routing area to generate the at least one security key.

30. The apparatus according to claim 26, wherein the at least one security key to be generated comprises a security key for use by one of non access stratum signaling and user data protection.

31. An apparatus, comprising:
a receiving means for receiving a predetermined event; and
a security key generating means for generating, in response to the received predetermined event, at least one security key for use in wireless communication between a mobile station and an access network element,
wherein the security key generating means includes means for utilizing a randomly allocated temporary identifier associated with the mobile station.

32. A computer program embodied on a computer readable medium, the computer program controlling a data processing device to perform:
generating, in response to a predetermined event, at least one security key for use in wireless communication between a mobile station and an access network element by utilizing a randomly allocated temporary identifier associated with the mobile station.
